(19) United States
(12) Patent Application Publication
(10) Pub. No.: US 2026/0208507 A1
(43) Pub. Date: Jul. 23, 2026

(54) INFORMATION PROCESSING APPARATUS AND NON-TRANSITORY COMPUTER-READABLE STORAGE MEDIUM STORING PROGRAM

(71) Applicant: SEIKO EPSON CORPORATION, TOKYO (JP)

(72) Inventor: Toshiya KONDO, Shiojiri-shi (JP)

(21) Appl. No.: 19/454,484

(22) Filed: Jan. 21, 2026

(30) Foreign Application Priority Data
Jan. 21, 2025 (JP) 2025-008187

(51) Int. Cl. B41J 11/00; B41J 11/66

(52) U.S. Cl. CPC B41J 11/008; B41J 11/663

(57) ABSTRACT

There is provided an information processing apparatus including, with a surface to which ink for forming a print image is applied to a transparent or translucent medium as a first surface and a surface opposite to the first surface as a second surface, a reception unit that receives selection of one mode of a first mode for executing post-processing from the first surface side by a post-processing apparatus that executes the post-processing and a second mode for executing the post-processing from the second surface side by the post-processing apparatus, and a placement unit that sets different placements of an object contained in the print image and used for the post-processing when viewed from the first surface side depending on the mode received by the reception unit.

The present application is based on, and claims priority from JP Application Serial Number 2025-008187, filed Jan. 21, 2025, the disclosure of which is hereby incorporated by reference herein in its entirety.

### BACKGROUND

### 1. Technical Field

The present disclosure relates to an information processing apparatus and a non-transitory computer-readable storage medium storing a program.

### 2. Related Art

In the related art, there is known a cutting apparatus that performs cutting processing of an image formed on a sheet medium by moving a carriage holding a cutter with the edge of the cutter in contact with or separated from the sheet medium and conveying the sheet medium in a conveyance direction orthogonal to a direction of movement of the carriage (for example, JP-A-2023-105696). In JP-A-2023-105696, a sheet medium 2 has a code mark 2b and a register mark 2c at predetermined positions for each image 2a. The code mark 2b is a barcode mark for optically reading the image information and the register mark 2c of the image 2a, and the register mark 2c is a mark for alignment of the cut line of the image 2a. In general, the image information, the code mark, and the register mark are read from the first surface, which is the printing surface side of the sheet medium, and are cut.

JP-A-2023-105696 is an example of the related art.

However, there is a need to read image information and objects including a code mark and a register mark from a second surface which is a surface opposite to the first surface of the sheet medium and execute post-processing.

### SUMMARY

In order to solve the above-described problem, an information processing apparatus according to an aspect of the present disclosure includes, with a surface to which ink for forming a print image is applied to a transparent or translucent medium as a first surface and a surface opposite to the first surface as a second surface, a reception unit that receives selection of one mode of a first mode for executing post-processing from the first surface side by a post-processing apparatus that executes the post-processing and a second mode for executing the post-processing from the second surface side by the post-processing apparatus, and a placement unit that sets different placements of an object contained in the print image and used for the post-processing when viewed from the first surface side depending on the mode received by the reception unit.

In order to solve the above-described problem, a non-transitory computer-readable storage medium storing a program according to the present disclosure causes a computer to function as, with a surface to which ink for forming a print image is applied to a transparent or translucent medium as a first surface and a surface opposite to the first surface as a second surface, a reception function of receiving selection of one mode of a first mode for executing post-processing from the first surface side by a post-processing apparatus that executes the post-processing and a second mode for executing the post-processing from the second surface side by the post-processing apparatus, and a placement function of setting different placements of an object contained in the print image and used for the post-processing when viewed from the first surface side depending on the mode received by the reception function.

In order to solve the above-described problem, an information processing apparatus according to an aspect of the present disclosure includes, with a surface to which ink for forming a print image is applied to a transparent or translucent medium as a first surface and a surface opposite to the first surface as a second surface, placing both a first object contained in the print image for execution of post-processing from the first surface side by a post-processing apparatus that executes the post-processing and a second object contained in the print image for execution of the post-processing from the second surface side by the post-processing apparatus, and setting different placements for the first object and the second object from each other when viewed from the first surface side.

### BRIEF DESCRIPTION OF THE DRAWINGS

FIG. 1 is a block diagram showing an overall configuration.

FIG. 2 is a block diagram showing a configuration of a cutting machine.

FIG. 3 shows an example of a printed matter.

FIG. 4 is a schematic cross-sectional view of the printed matter taken along line A-A in FIG. 3.

FIG. 5 is a schematic cross-sectional view of the printed matter taken along line B-B in FIG. 3.

FIG. 6 is a block diagram showing a configuration of a printing apparatus.

FIG. 7 shows an example of a screen of an application.

FIG. 8 shows an example of the screen of the application.

FIG. 9 shows an example of the screen of the application.

FIG. 10 is a flowchart showing control processing of an information processing apparatus.

FIG. 11 shows first cut data.

FIG. 12 shows second cut data.

FIG. 13 shows an example of the screen of the application.

### DESCRIPTION OF EMBODIMENTS

Embodiments of the present disclosure will now be described in the following order.
(1) Overall Configuration
(2) Detailed Configuration of Cutting Machine
(3) Detailed Configuration of Printing Apparatus
(4) Detailed Configuration of Printing Terminal
(5) Control Processing of Information Processing Apparatus
(6) Other Embodiments

### (1) Overall Configuration

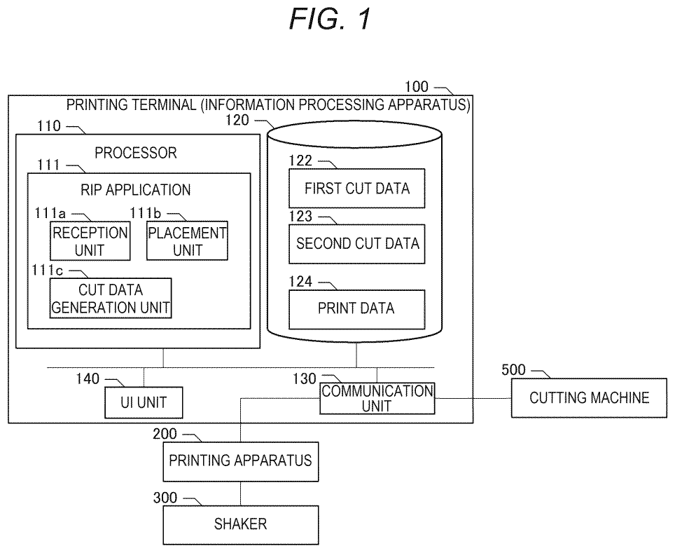

FIG. 1 shows a configuration of an entire system including a printing terminal 100 as an information processing apparatus according to an embodiment of the present disclosure. The printing terminal 100 executes a RIP (Raster Image Processor) application 111 to receive an image to be printed and generate an image that is placed and set on a medium according to a printing condition and a cut condition. Then, the printing terminal 100 executes the RIP application 111 to generate print data 124 to be printed by a printing apparatus 200 from the generated image, and causes the printing apparatus 200 to print the print data. The printing terminal 100 executes the RIP application 111 to generate at least one of first cut data 122 and second cut data 123 indicating a cut operation command from the image to be printed, and transmits the generated data to a cutting machine 500. The first cut data 122 and the second cut data 123 will be described later.

The printing apparatus 200 of the present embodiment prints an image on a film-shaped transparent or translucent medium wound in a roll shape. A shaker 300 is coupled to the printing apparatus 200, and an auxiliary agent (powder) for transferring the image to clothes or the like is applied onto the medium after printing. The cutting machine 500 cuts the medium with the image printed thereon based on the first cut data 122 or the second cut data 123 generated according to the shape of the image.

### (2) Detailed Configuration of Cutting Machine

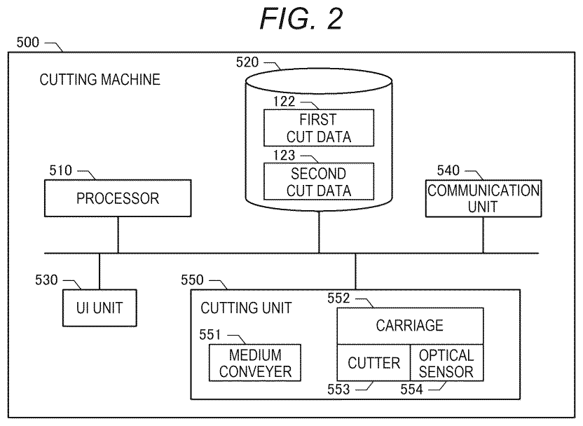

FIG. 2 is a block diagram illustrating a configuration of the cutting machine 500 as an example of a post-processing apparatus. The cutting machine 500 is also referred to as a cutting plotter.

The cutting machine 500 includes a processor 510, a nonvolatile memory 520, a UI unit 530, a communication unit 540, and a cutting unit 550. The processor 510 includes a CPU, a ROM, a RAM, and the like, not illustrated, and executes a cutting control program recorded in the nonvolatile memory 520 to control each unit of the cutting machine 500.

The processor 510 may be configured with a single chip or a plurality of chips, or may be configured as an SoC with various functional blocks. For example, the CPU may be replaced with an ASIC, or the CPU and an ASIC may cooperatively operate. When another apparatus (for example, the printing terminal 100, the printing apparatus 200, or the like) in the present embodiment includes a processor, the processor can be implemented in various configurations like the processor 510.

The UI unit 530 includes a touch panel display, a switch, an LED, a speaker, and the like. The UI unit 530 presents various kinds of information related to the cutting machine 500 to a user of the cutting machine 500 and accepts an operation from the user under the control of the processor 510. The communication unit 540 includes a communication interface for communicating with another device according to various protocols for wired or wireless communication. In the present embodiment, the cutting machine 500 can communicate with the printing terminal 100 via the communication unit 540. Upon receiving first cut data 122 or the second cut data 123 for executing the cut operation from the printing terminal 100, the processor 510 stores the cut data in the nonvolatile memory 520.

The cutting unit 550 includes a medium conveyer 551, a carriage 552, a cutter 553, and an optical sensor 554. In the present embodiment, the medium conveyer 551 includes a sensor, an actuator, and a mechanical component for conveying a printed matter which is a medium in the roll form and is produced by the printing apparatus 200 based on the first cut data 122 or the second cut data 123. The cutter 553 includes a cutter blade that cuts the medium, and an actuator that drives the cutter blade in a direction orthogonal to the surface of the medium.

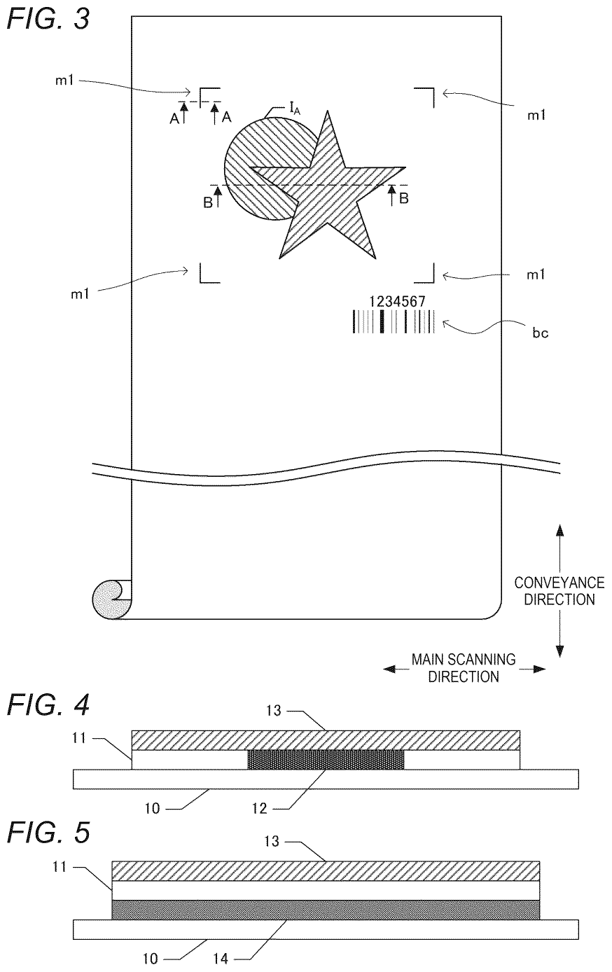

FIG. 3 is a schematic diagram showing an example of a printed matter, and shows a conveyance direction as a direction in which a medium is conveyed when set in the cutting machine 500, and a main scanning direction as a direction of scanning with the carriage 552. The main scanning direction is a direction orthogonal to the conveyance direction of the medium. The carriage 552 is supported by a rail or the like, not illustrated. The carriage 552 is moved in a direction parallel to a printing surface of the medium by a motor, an actuator, and a mechanical component, not illustrated. Here, the direction parallel to the printing surface of the medium is, for example, the main scanning direction. The cutter 553 and the optical sensor 554 are mounted on the carriage 552. The carriage 552 is provided with a holder, not illustrated. The holder is at the attachment position of the cutter blade of the cutter 553, and the cutter blade is detachably held via the holder provided in the carriage 552. The cutter blade held by the holder of the carriage 552 in this manner is driven in a direction orthogonal to the surface of the sheet-shaped medium by an actuator, not illustrated, and the edge of the cutter blade is brought into contact with or moved away from the medium. With the edge of the cutter blade in contact with the medium, the carriage 552 holding the cutter blade moves in the main scanning direction and the medium is conveyed in the conveyance direction orthogonal to the direction of movement of the carriage 552, thereby performing cutting processing of the image formed on the medium. The cutting machine may be a flat-bed type apparatus in which the medium conveyer is omitted, and in this case, the direction of movement of the carriage 552 is not limited to only the width direction (direction corresponding to the main scanning direction) of the medium and includes the longitudinal direction (direction corresponding to the conveyance direction) orthogonal to the width direction of the medium. The configuration of the cutting machine is not particularly limited as long as the cutting machine executes cutting by scanning with the cutter mounted on the carriage.

The optical sensor 554 moves while being held by the carriage 552. The optical sensor 554 includes a light emitting unit and a light receiving unit, and reads an object printed on a medium by emitting light to the medium and receiving reflected light from the medium. In the present embodiment, the object is a barcode bc for designating a method of the post-processing and a cut mark m1 which is a figure for specifying a position of the post-processing. The barcode bc is used to identify a cut job in the cutting machine 500 used in a subsequent process. The cut mark m1 is also referred to as a register mark. In the present embodiment, the post-processing is cutting processing of cutting the medium. The cut mark m1 is a mark used for alignment with the medium on which the image to be cut by the cutting machine 500 is printed, and the image to be cut is printed in a rectangular area having a reference point of each cut mark m1 as a vertex. The barcode bc includes reference information for referring to the positions of the cut marks m1 and the first cut data 122 or the second cut data 123, which is a vector data group (a set of vectors defining a cutting start position and a cutting end position) for cutting the image present in the rectangular area indicated by the cut marks m1 along a cut line. The reference information may be in any form as long as the processor 510 can acquire desired cut data, and is represented by, for example, a path indicating a storage location of the first cut data 122 or the second cut data 123, a file name of the first cut data 122 or the second cut data, or the like.

When instructed to read the barcode via the UI unit 530, the processor 510 causes the medium conveyer 551 to convey the medium, moves the carriage 552, and causes the optical sensor 554 to read the barcode. When the read barcode indicates the reference information of the first cut data 122 or the second cut data 123, the processor 510 acquires the first cut data 122 or the second cut data 123 from the printing terminal 100 based on the reference information. Furthermore, the processor 510 reads the cut mark m1 and performs alignment for the cut operation. For example, a position on the medium indicated by one of the four cut marks m1 is used as a reference for driving the medium conveyer 551 and the carriage 552. The processor 510 acquires the first cut data 122 or the second cut data 123 based on the reference information indicated by the barcode, controls the medium conveyer 551, the carriage 552, and the cutter 553 based on the vector data group indicated by the first cut data 122 or the second cut data 123, and performs the cut operation.

The example in which the optical sensor 554 mounted on the carriage 552 reads the barcode bc and the cut mark m1 has been described, but the configuration for reading the barcode bc or the cut mark m1 is not limited thereto. For example, a cutting machine provided with an optical sensor having an image capture range including the entire of a set medium may be adopted. The barcode bc may be replaced with a two-dimensional code, a numeral, a character, a symbol, or the like.

FIG. 4 is a schematic cross-sectional view taken along line A-A in the printed matter of FIG. 3, and FIG. 5 is a schematic cross-sectional view taken along line B-B in the printed matter of FIG. 3. FIG. 4 shows a method of printing the cut mark m1. A line of a cut mark is printed with black ink 12 on a transparent or translucent medium 10, and another portion is printed with white ink 11 for a predetermined width from the black portion. An auxiliary agent 13 is applied onto the white ink 11 and the black ink 12 by the shaker 300. In a case where printing is not performed with the white ink 11 adjacent to the black ink 12, the cut mark m1 may not be appropriately recognized when the color of the mounting table of the cutting machine 500 is close to black. Specifically, the medium 10 in the present embodiment is transparent or translucent. For this reason, in a case where the cut mark is printed with only the black ink 12, when the mounting table is close to black, the contrast between the color of the mounting table and the color of the cut mark is lower, and the reading may be difficult when the cut mark is read by the cutting machine 500 to be described later. However, when printing is performed with the white ink 11 adjacent to the black ink 12 as in the present embodiment, the cut mark m1 can be recognized regardless of the color of the mounting table of the cutting machine 500. FIG. 5 shows a method of printing an image IA. The image IA is printed on the transparent or translucent medium 10 with CMYK ink 14, and printing is performed with the white ink 11 on the CMYK ink 14. The auxiliary agent 13 is applied onto the white ink 11 by the shaker 300. Printing is performed with the white ink 11 on the CMYK ink 14, and thus the color contrast can be increased. Similarly to the cut mark, the barcode bc is printed with black ink for bars and associated numbers, and is printed with white ink for a predetermined width from the black portion.

### (3) Detailed Configuration of Printing Apparatus

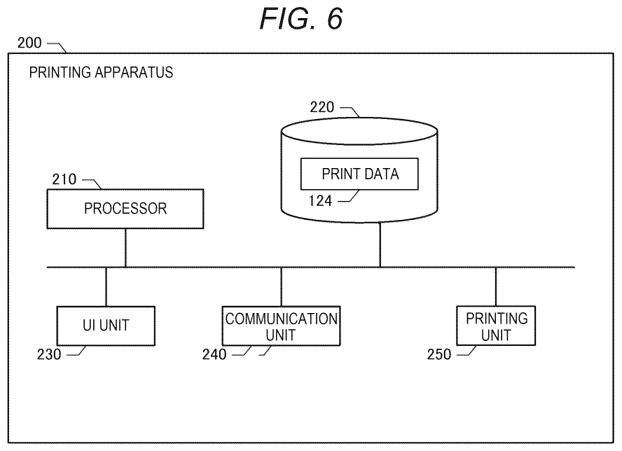

FIG. 6 is a block diagram showing a configuration of the printing apparatus 200 shown in FIG. 1. The printing apparatus 200 includes a processor 210, a nonvolatile memory 220, a UI unit 230, a communication unit 240, and a printing unit 250. The processor 210 executes a control program, not illustrated, which is recorded in the nonvolatile memory 220, and thus can control each unit of the printing apparatus 200.

The nonvolatile memory 220 stores the print data 124 transmitted from the printing terminal 100, and the processor 210 controls the printing unit 250 based on the print data 124 to execute printing.

The UI unit 230 includes a touch panel display, a key, an LED, a speaker, and the like. The processor 210 guides the user to various kinds of information via an output unit such as a touch panel display, an LED, or a speaker, and inputs an instruction of the user via an input unit such as a touch panel display or a key.

The communication unit 240 includes a communication interface for communicating with another device according to various protocols for wired or wireless communication. In the present embodiment, the processor 210 can communicate with the printing terminal 100 via the communication unit 240. The communication unit 240 may include an interface for communicating with various removable memories attached to the printing apparatus 200.

In the present embodiment, the printing unit 250 executes printing on a film-shaped transparent or translucent medium wound in a roll shape. The printing unit 250 includes a medium conveyer and a carriage with a print head mounted thereon, not illustrated. The print head includes nozzle rows corresponding to, for example, cyan, magenta, yellow, and black inks, and the inks are ejected from the nozzles provided in the nozzle rows. In the present embodiment, a direction in which a medium is conveyed during printing of an image is a conveyance direction (sub-scanning direction), and a direction orthogonal to the conveyance direction is the main scanning direction. In other words, the conveyance direction is the longitudinal direction of the roll-shaped medium, and the main scanning direction is the width direction of the roll-shaped medium. That is, the direction of the relative movement between the printing unit 250 and the medium in the period in which the ink is applied to the medium by the printing unit 250 of the printing apparatus 200 that forms the print image is defined as the main scanning direction. The carriage reciprocates along the main scanning direction. The medium conveyer conveys a print target medium. The medium conveyer conveys the medium in a direction orthogonal to the main scanning direction. The ejection of the inks from the nozzles in the process of the reciprocation of the print head and the conveyance of the medium by the medium conveyer are repeated, thereby performing printing on the medium.

The user sets the medium in the printing apparatus 200 and operates the printing terminal 100 to instruct the printing apparatus 200 to execute printing. In addition, the user removes and moves the medium (printed matter) after printing from the printing apparatus 200, applies the auxiliary agent by the shaker 300, sets the medium in the cutting machine used in the cutting process which is a process after the printing process, and causes the cutting machine 500 to execute the cut operation on the medium.

### (4) Detailed Configuration of Printing Terminal

The configuration of the printing terminal 100 will be described with reference to FIG. 1. The printing terminal 100 is, for example, a computer (information processing apparatus) such as a PC or a tablet. The printing terminal 100 includes a processor 110, a nonvolatile memory 120 functioning as a storage unit, a communication unit 130, and a UI unit 140. The non-volatile memory 120 stores the RIP application 111 and other various programs. When at least one of the print data 124, the first cut data 122, and the second cut data 123 is generated, the generated data may be stored in the nonvolatile memory 120.

The RIP application 111 is executed by the processor 110 not only to generate a raster image for execution of printing by the printing apparatus 200, but also to execute various kinds of processing including placement processing, which will be described later. Hereinafter, the processing implemented by the function of the RIP application 111 is referred to as RIP processing.

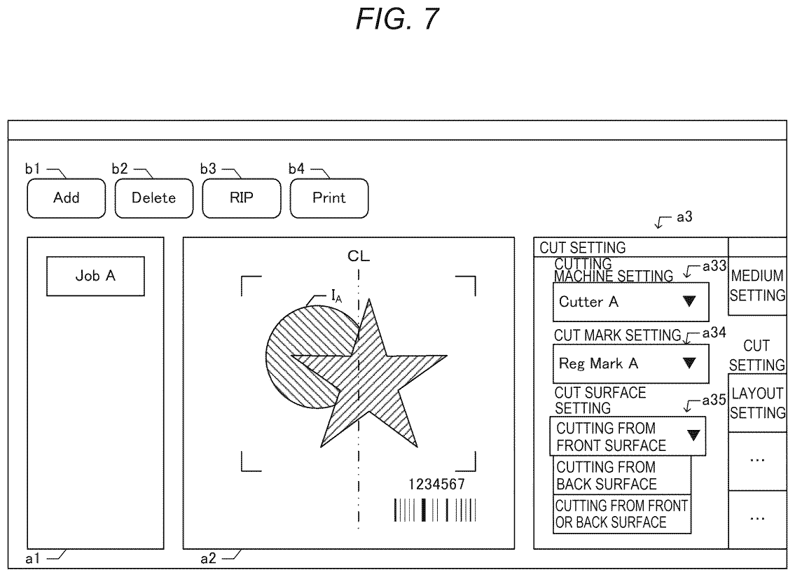

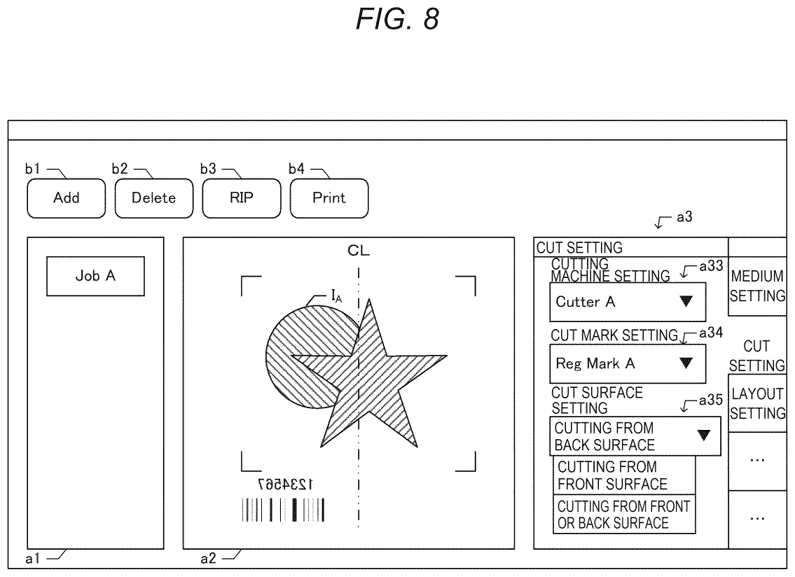

In the present embodiment, the processor 110 executes the RIP application 111 to execute a function of a reception unit 111a, a function of a placement unit 111b, a function of a print data generation unit, not illustrated, and a function of a cut data generation unit 111c. Here, a surface of a transparent or translucent medium to which ink for forming a print image is applied is a first surface, and a surface opposite to the first surface is a second surface. Hereinafter, the first surface may be referred to as a front surface, and the second surface may be referred to as a back surface. The function of the reception unit 111a is a function of receiving selection of one of a first mode for executing post-processing from the first surface side by the cutting machine 500 and a second mode for executing post-processing from the second surface side by the cutting machine 500. The term “translucent” refers to the degree of transparency that the optical sensor 554 of the cutting machine 500 can recognize the cut mark m1 from the second surface side. The first mode refers to a mode when cutting from the front surface is selected in a cut surface setting portion a35 (see FIG. 7), and the second mode refers to a mode when cutting from the back surface is selected in the cut surface setting portion a35 (see FIG. 8). Reception of the selection of the mode refers to reception of the selection of the cutting from the front surface or the cutting from the back surface from the user in the cut surface setting portion a35. In the present embodiment, the function of the placement unit 111b is a function of setting different placements of an object contained in the print image and used for post-processing when viewed from the first surface side in the main scanning direction depending on the mode received by the reception unit. When an object to be placed by the placement unit 111b in the first mode is a first object and an object to be placed by the placement unit 111b in the second mode is a second object, the placement unit 111b sets the content of the first object when viewed from the first surface side and the content of the second object when viewed from the first surface side in an inversion symmetrical relationship in the main scanning direction. That is, the first object and the second object have a horizontally-inverted relationship with a center line CL (see FIGS. 7 and 8) described later as an axis of symmetry. In the present embodiment, setting the contents of the first object and the second object in the inversion symmetrical relationship refers to not only setting the placements to be inversion symmetrical but also setting the contents of the first object and the second object themselves to be inversion symmetrical. Each of the first object and the second object includes a cut mark and a barcode. In the present embodiment, since the cut mark is bilaterally symmetrical, the content does not change even when the cut mark is horizontally inverted, but when the cut mark is not bilaterally symmetrical, the content changes when the cut mark is horizontally inverted. As described above, according to the placement unit 111b that uses different placements of the object used for post-processing when viewed from the first surface side depending on the mode received by the reception unit 111a, more specifically, that sets the position and the content of the first object and the position and the content of the second object when viewed from the first surface side in the inversion symmetrical relationship in the main scanning direction, it is possible to bring the position of the first object when the medium is set on the mounting table of the cutting machine 500 for cutting from the front surface and the position of the second object when the medium is set on the mounting table of the cutting machine 500 for cutting from the back surface close to each other. Therefore, the cutting machine 500 can appropriately read the objects by the optical sensor 554 and perform cutting. That is, it is possible to support both cutting from the front surface and cutting from the back surface. In contrast, when the medium is set on the mounting table of the cutting machine 500 and the positions of the objects are greatly separated in the case of cutting from the front surface and the case of cutting from the back surface, particularly in the case of cutting from the back surface, it may be impossible for the cutting machine 500 to appropriately read the objects by the optical sensor 554 and perform the cutting processing. The first object can be detected from the first surface by a post-processing apparatus that executes post-processing, and the second object can be detected from the second surface by the post-processing apparatus. In the present embodiment, the post-processing is cutting processing, and the post-processing apparatus is the cutting machine 500.

The function of the print data generation unit is a function of generating print data based on an image to be printed, a print condition, and a cut condition and causing the printing apparatus 200 to execute printing. The function of the cut data generation unit 111c is a function of generating cut data to be used by the cutting machine 500 (cutting processing apparatus) that executes cutting processing. In the present embodiment, the function of the cut data generation unit 111c is a function of generating cut data indicating a cut operation command according to the shape of the image from the image to be printed. The cut data generation unit 111c generates the first cut data 122 when the reception unit 111a receives the selection of the first mode, and generates the second cut data 123 different from the first cut data 122 when the reception unit 111a receives the selection of the second mode. As a result, since the cut data can be appropriately generated according to the selection of the front and back cut surfaces, it is possible to support both cutting from the front surface and cutting from the back surface. The cut data generation unit 111c sets the first cut data 122 and the second cut data 123 in an inversion symmetrical relationship in the main scanning direction.

The UI unit 140 (see FIG. 1) includes a display, a touch panel, a speaker, a microphone, and the like. In the present embodiment, the processor 110 inputs various instructions from the user and outputs various kinds of information to the user via the UI unit 140.

The communication unit 130 includes an interface circuit for communicating with another device. The processor 110 can communicate with the printing apparatus 200 and the cutting machine 500 via the communication unit 130. Peripheral devices such as a keyboard, a mouse, and a display may be coupled to the printing terminal 100 via the communication unit 130, and the processor 110 may be configured to input various kinds of information from these peripheral devices or output various kinds of information thereto.

FIGS. 7, 8, and 9 show examples of a screen displayed on the display of the UI unit 140 when the processor 110 executes the RIP application 111. The screen of the RIP application 111 includes an Add button b1, a Delete button b2, a RIP button b3, and a Print button b4. The screen of the RIP application 111 includes an image list portion a1, a preview portion a2, and a parameter setting portion a3.

The Add button b1 is a button for an operation of selecting and adding an image to be printed, and the Delete button b2 is a button for selecting one of images to be printed and excluding the selected image from the images to be printed. The image list portion a1 is an area for displaying the names of images currently selected to be printed, in a list format.

The parameter setting portion a3 is a setting portion for receiving the designation of various parameters including a medium setting and a cut setting (see FIGS. 7, 8, and 9), and a layout setting. The preview portion a2 is an area for displaying a preview image of a printed matter when applying each parameter selected in the parameter setting portion a3 and printing the image currently selected to be printed.

The RIP button b3 is a button for giving an instruction to perform the RIP processing of the image displayed in the preview portion a2 and generating the print data 124. The print data 124 is at least data after the execution of rasterization processing (or may be data after color conversion processing or halftone processing). The Print button b4 is a button for instructing the printing apparatus 200 designated by the user to execute print processing based on the generated print data 124.

With the function of the reception unit 111a, the processor 110 receives an image to be printed. Specifically, the processor 110 receives an image designated by the user with the Add button b1 as an image to be printed. The processor 110 receives a print condition, which is a setting value designated by the user in relation to the printing operation in the parameter setting portion a3.

Furthermore, with the function of a cutting machine designation portion, not illustrated, of the RIP application 111, the processor 110 receives cutting machine designation information, not illustrated, which is information about the cutting machine for cutting the medium. The cutting machine designation information includes information indicating the type of the cutting machine. The user can display the cut setting shown in FIGS. 7, 8, and 9 in the parameter setting portion a3 by selecting the cut setting on a setting menu tab. A cutting machine setting portion a33 is an operation portion that presents a list of available cutting machines for selection. The list of available cutting machines may be configured to display the types of cutting machines manually registered by the user in advance, or may be configured to automatically detect cutting machines present in the same network as that of the printing terminal 100 and display the types of the detected cutting machines.

When the user selects one of the options from the list in the cutting machine setting portion a33, the processor 110 receives the selection. That is, the processor 110 receives the option selected by the user as the cutting machine designation information. When a cutting machine is designated in the cutting machine setting portion a33, a barcode corresponding to the cutting machine is designated. That is, when there is a different barcode specification for each cutting machine, a barcode corresponding to the specification is designated.

The image IA displayed in the preview portion a2 in FIGS. 7, 8, and 9 is a preview of an image JobA displayed in the image list portion a1. A cut mark setting portion a34 is a setting portion for setting the type of a cut mark for alignment for an image to be cut printed on the medium. The cut mark is a mark indicating a reference position when the cutting machine executes the cut operation. In the present embodiment, the cut mark is in the form of two line segments intersecting at a right angle at ends (so-called L-shape).

Furthermore, the processor 110 displays a barcode related to the cut operation to be executed by the cutting machine in the preview portion a2. That is, the processor 110 generates a barcode indicating the reference information of the cut data, and displaces the barcode bc at a position apart from the cut mark m1 by a predetermined distance outside the rectangular area having the reference point of the cut mark m1 as a vertex.

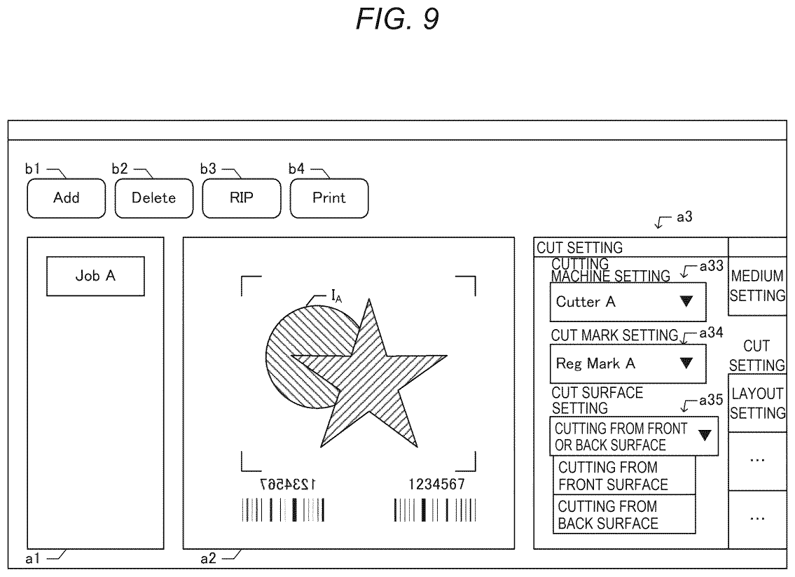

The cut surface setting portion a35 is a setting portion for setting one of a mode for cutting from the front surface, the first surface, (first mode), a mode for cutting from the back surface, the second surface, (second mode), and a mode for cutting from the front or back surface (either the first surface or the second surface). In FIG. 7, the placement of object when viewed from the first surface side in the case of cutting from the front surface (first surface) is indicated in the preview portion a2. It is assumed that the position at which the cutting machine can read the barcode bc is a position downstream in the conveyance direction and downstream in the main scanning direction (that is, the lower right of the image IA illustrated in FIG. 7) when printed. This placement is a normal placement. In FIG. 8, the placement of the object when viewed from the first surface side in the case of cutting from the back surface (second surface) is indicated in the preview portion a2. This placement is a placement in which the object is changed from a normal placement to an inversion symmetrical position in the main scanning direction with the center line CL as an axis of symmetry. Furthermore, in the present embodiment, the contents of the objects are set in an inversion symmetrical relationship. That is, in FIG. 8, the barcode bc and the associated numbers are set in an inversion symmetrical relationship with respect to FIG. 7. The center line CL is displayed for convenience of description, and is not necessarily actually displayed in the preview portion a2. In FIG. 9, the placement of the object when viewed from the first surface side in the case of cutting from the front or back surface is indicated in the preview portion a2. The case of cutting from the front or back surface refers to a case where it is not determined whether to cut from the front surface or cut from the back surface by the cutting machine at the time of printing. When cutting from the front or back surface is selected, the processor 110 places both the first object contained in the print image for execution of post-processing from the first surface side by the cutting machine 500 and the second object contained in the print image for execution of post-processing from the second surface side by the cutting machine 500. The processor 110 sets different placements of the first object and the second object from each other when viewed from the first surface side. In the present embodiment, setting the different placements of the first object and the second object from each other refers to setting the placements different in the main scanning direction. That is, both the object in the case of cutting from the front surface and the object in the case of cutting from the back surface are placed. Accordingly, it is not necessary to select the front and back cut surfaces at the stage of printing, and it is possible to appropriately support both the cutting from the front surface and the cutting from the back surface according to the direction in which the objects are placed in the cutting device. The settings menu related to the cutting is not limited, but includes various other menus. The processor 110 places the cut mark m1 outside the area occupied by all the placed image objects.

### (5) Control Processing of Information Processing Apparatus

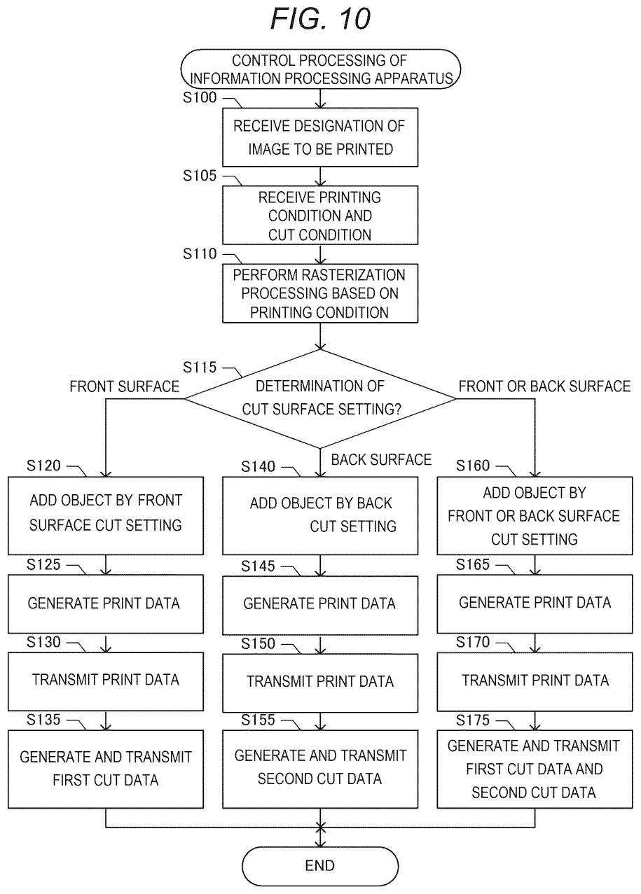

FIG. 10 is a flowchart showing control processing of the information processing apparatus. The processing in FIG. 10 is started when the RIP application is activated in the printing terminal 100. As the control processing is started, the processor 110 receives a designation of an image to be printed (step S100). In the present embodiment, the image to be printed includes a plurality of objects (images, characters, and the like) defined by PDF-format data. Specifically, when the user operates the Add button b1 on the screen shown in FIGS. 7, 8, and 9 to perform an operation of adding an image to be printed, the processor 110 acquires the added image as an image to be printed.

Subsequently, the processor 110 receives a print condition and a cut condition of the received image to be printed (step S105). Specifically, when the user selects each setting tab of the parameter setting portion a3 and inputs desired settings (medium setting, cut setting, layout setting, and the like), the processor 110 receives the input setting values. The setting values set at the time include setting values of a print medium, print quality, and a layout. In the present embodiment, a film is designated as the print medium. The setting values of the cut setting include a setting value of the cutting machine setting portion a33 for designating a cutting machine to be used, a setting value of the cut mark setting portion a34 for designating a type of a cut mark to be displayed, and a setting value of the cut surface setting portion a35 for designating whether to cut from the front surface, the back surface, or the front or back surface as shown in FIGS. 7, 8, and 9.

Subsequently, the processor 110 performs rasterization processing based on the print condition (step S110). Specifically, when the RIP button b3 is pressed by the user, rasterization processing is performed.

Subsequently, the processor 110 determines which of the front surface cut setting, the back surface cut setting, and the front or back surface cut setting is enabled in the cut surface setting portion a35 (step S115).

When the front surface cut setting is enabled, images (objects) obtained by rasterizing the cut marks and the barcode are added to the rasterized image in step S110 at normal positions based on the front surface cut setting (step S120). This image is a final image. In the present embodiment, the normal positions of the cut marks refer to positions of four corners surrounding the image to be printed, and the normal position of the barcode refers to a predetermined position of the image to be printed (for example, the lower right of the image to be printed) when viewed from the first surface side.

Subsequently, the processor 110 generates the print data 124 (see FIGS. 1 and 6) from the final image (step S125). When the Print button b4 is pressed by the user, the generated print data 124 is transmitted to the printing apparatus 200 (step S130). Then, the printing apparatus 200 performs printing according to the print data 124. That is, the printing apparatus 200 prints an image equivalent to the preview image displayed in the preview portion a2 illustrated in FIG. 7.

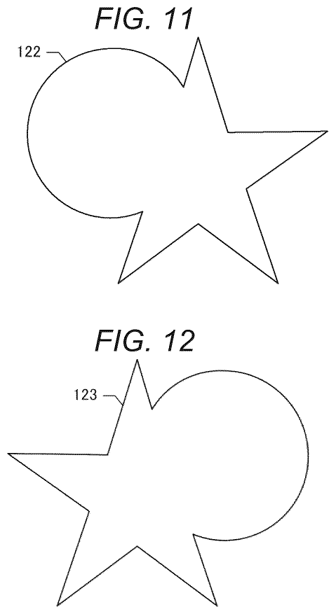

FIG. 11 shows the first cut data 122. The first cut data 122 is data obtained by extracting the contour of the image IA illustrated in FIGS. 7, 8, and 9. Subsequently, the processor 110 generates the first cut data 122 (see FIGS. 1, 2, and 11) in which cut line information contained in the image to be printed is not horizontally inverted, and transmits the first cut data to the cutting machine 500 (step S135). The cut line information is information indicating a contour line for cutting out the image to be printed and, in the present embodiment, image information indicating the contour of the image to be printed. When the image to be printed is defined by the PDF-format data, the cut line information can be defined as image information on a layer indicating a characteristic image. The processor 110 forms the first cut data 122 by defining lines indicated by the cut line information as cut positions, and defining a vector data group (a set of vectors defining a cutting start position and a cutting end position) necessary for cutting at each cut position by position with reference to the cut marks. The first cut data 122 is stored in the nonvolatile memory 520 of the cutting machine 500. Then, the cutting machine 500 performs cutting from the front surface based on the first cut data 122 with the printed matter set on the cutting machine 500 with the front surface facing upward by the user. Specifically, the processor 510 of the cutting machine 500 reads the barcode at the predetermined position (lower right) with the optical sensor 554, specifies the reference information, and acquires the first cut data 122 indicated by the reference information. Then, the processor 510 performs alignment using the cut marks and performs cutting according to each vector indicated by the first cut data 122.

In contrast, when the back surface cut setting is enabled in step S115, images (objects) obtained by rasterizing the cut marks and the barcode of the front surface cut setting horizontally inverted with the center line CL (see FIGS. 7 and 8) as the axis of symmetry are added to the rasterized image in step S110 based on the back surface cut setting (step S140). That is, not only the cut marks and the barcode are placed at positions horizontally inverted from the normal positions, but also the contents of the cut marks and the barcode are horizontally inverted and added. This image is a final image.

Subsequently, the processor 110 generates the print data 124 (see FIGS. 1 and 6) from the final image (step S145). When the Print button b4 is pressed by the user, the generated print data 124 is transmitted to the printing apparatus 200 (step S150). Then, the printing apparatus 200 performs printing according to the print data 124. That is, the printing apparatus 200 prints an image equivalent to the preview image displayed in the preview portion a2 illustrated in FIG. 8.

FIG. 12 shows the second cut data 123. The second cut data 123 is contour data obtained by horizontally inverting the first cut data 122 shown in FIG. 11. Subsequently, the processor 110 generates the second cut data 123 (see FIGS. 1, 2, and 12) in which the cut line information contained in the image to be printed is horizontally inverted, and transmits the second cut data to the cutting machine 500 (step S155). That is, the processor 110 generates an image including the cut line information and the cut marks, generates an inversion symmetrical image with reference to the center line CL, and performs the same processing as in step S135. The processor 110 forms the second cut data 123 by defining lines indicated by the cut line information as cut positions, and defining a vector data group (a set of vectors defining a cutting start position and a cutting end position) necessary for cutting at each cut position by position with reference to the cut marks. The second cut data 123 is stored in the nonvolatile memory 520 of the cutting machine 500. Then, the cutting machine 500 performs cutting from the back surface based on the second cutting data 123 with the printed matter set on the cutting machine 500 with the back surface facing upward by the user. Specifically, the processor 510 of the cutting machine 500 reads the barcode at the predetermined position (lower right) with the optical sensor 554, specifies the reference information, and acquires the second cut data 123 indicated by the reference information. Then, the processor 510 performs alignment using the cut marks and performs cutting according to each vector indicated by the second cut data 123.

In contrast, when the front or back surface cut setting is enabled, images (objects) obtained by rasterizing the cut marks and the barcode are added at normal positions and images (objects) obtained by rasterizing the cut marks and the barcode added at the normal positions horizontally inverted with the center line CL (see FIGS. 7 and 8) as the axis of symmetry are added to the rasterized image in step S110 based on the front or back surface cut setting (step S160). This image is a final image.

Subsequently, the processor 110 generates the print data 124 (see FIGS. 1 and 6) from the final image (step S165). When the Print button b4 is pressed by the user, the generated print data 124 is transmitted to the printing apparatus 200 (step S170). Then, the printing apparatus 200 performs printing according to the print data 124. That is, the printing apparatus 200 prints an image of the preview image displayed in the preview portion a2 illustrated in FIG. 9.

Subsequently, the processor 110 generates the first cut data 122 (see FIGS. 1, 2, and 11) in which the cut line information contained in the image to be printed is not horizontally inverted, generates the second cut data 123 (see FIGS. 1, 2, and 12) in which the cut line information is horizontally inverted, and transmits the two pieces of cut data to the cutting machine 500 (step S175). When the user sets the printed matter on the cutting machine 500 with the front surface facing upward, the cutting machine 500 performs cutting from the front surface based on the first cut data 122. Specifically, the processor 510 of the cutting machine 500 reads the barcode at the predetermined position (lower right) with the optical sensor 554, specifies the reference information, and acquires the first cut data 122 indicated by the reference information. Then, the processor 510 performs alignment using the cut marks and performs cutting according to each vector indicated by the first cut data 122. In contrast, when the user sets the printed matter on the cutting machine 500 with the back surface facing upward, the cutting machine 500 performs cutting from the back surface based on the second cutting data 123. Specifically, the processor 510 of the cutting machine 500 reads the barcode at the predetermined position (lower right) with the optical sensor 554, specifies the reference information, and acquires the second cut data 123 indicated by the reference information. Then, the processor 510 performs alignment using the cut marks and performs cutting according to each vector indicated by the second cut data 123.

In the related art, when a printed matter is cut in a subsequent process, cutting processing is often performed by bringing the blade of the cutting device into contact with a medium from a printing surface (front surface) of the medium. However, since an ink for forming an image, an ink serving as a base, and an auxiliary agent (powder) for transferring the image are applied to the printing surface of the medium, it may be impossible to appropriately perform cutting processing from the printing surface due to these factors.

For example, there are cases where the smoothness of the printing surface is impaired due to the ink and the auxiliary agent and the sliding of the blade of the cutting device becomes unsmooth (cases where wrinkles are produced and the blade wears out quickly), and where the cut marks and the barcode are hidden by the auxiliary agent and hard to be correctly read by the reading unit of the cutting device, and thus cutting processing cannot be started.

Under the circumstances, there is a need for a printing apparatus (and an information processing apparatus) capable of cutting from a back surface that is not a printing surface. In this regard, according to the present embodiment, it is possible to support both cutting from the front surface and cutting from the back surface.

### (6) Other Embodiments

The foregoing embodiment is an example for carrying out the present disclosure, and various other embodiments can be employed. For example, the information processing apparatus according to the present disclosure may be configured as integrated with the printing apparatus. The information processing apparatus may be configured as an apparatus (server) separate from the terminal operated by the user or the printing apparatus.

In the above embodiment, the post-processing is cutting processing, but is not limited to cutting processing. For example, in addition to the cutting processing, the present disclosure can be applied to processing for texturing a medium. In the above embodiment, one of the front surface cut setting, the back surface cut setting, and the front or back surface cut setting is selected, but one of the front surface cut setting and the back surface cut setting may be selected, and it is not essential that the front or back surface cut setting can be selected.

In the above embodiment, the objects used for the post-processing are the barcode bc for designating the post-processing method and the cut marks m1 as figures for specifying the position of the post-processing, but may be at least one of these. In the above embodiment, the objects used for the post-processing are the barcode bc and the cut marks m1, but may include other objects. For example, the object may include information on characters and numerals such as a work procedure, a delivery date, and a delivery destination displayed between jobs, and different placements of the object when viewed from the first surface side may be set depending on the mode received by the reception unit 111a. As a result, when the first mode is selected, the characters and numerals can be visually recognized from the first surface without any problem, and when the second mode is selected, the characters and numerals are printed in a horizontally inverted manner, so that the characters and numbers can be visually recognized from the second surface without any problem.

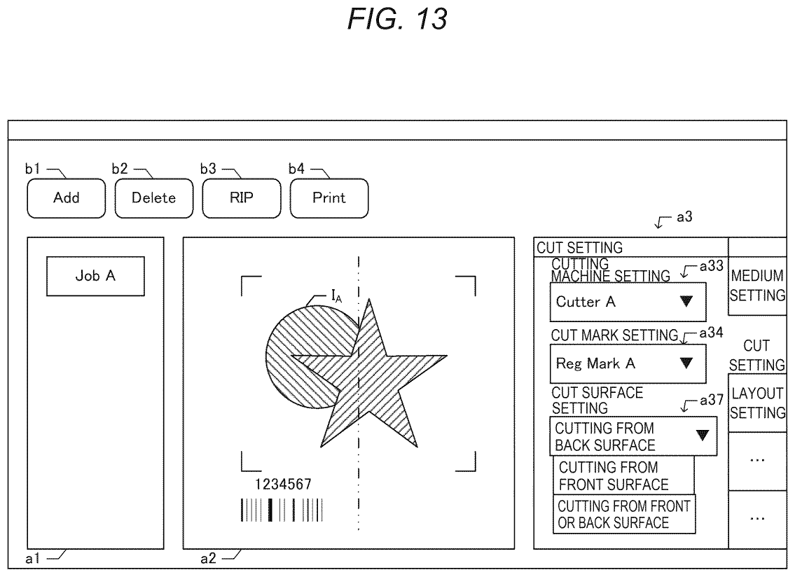

In the above embodiment, the placement unit 111b sets the content of the first object when viewed from the first surface side and the content of the second object when viewed from the first surface side in the inversion symmetrical relationship in the main scanning direction, but as illustrated in FIG. 13, only the placements may be set in an inversion symmetrical relationship instead of the contents. That is, the placement unit 111b may set the placement of the first object when viewed from the first surface side and the placement of the second object when viewed from the first surface side in an inversion symmetrical relationship in the main scanning direction. Since only the placement of the object is inversion symmetrically set and the inversion of the content of the object is unnecessary, it is possible to support both the cutting from the front surface and the cutting from the back surface with a simple configuration.

Moreover, the present disclosure is also applicable as a control method for a computer as an information processing apparatus. For example, the above description is also a disclosure of a control method including, with a surface to which ink for forming a print image is applied to a transparent or translucent medium as a first surface and a surface opposite to the first surface as a second surface, receiving selection of one mode of a first mode for executing post-processing from the first surface side by a post-processing apparatus that executes the post-processing and a second mode for executing the post-processing from the second surface side by the post-processing apparatus by a reception unit, and setting different placements of an object contained in the print image and used for the post-processing when viewed from the first surface side depending on the mode received by a reception function by a placement unit. This method can be implemented by causing a processor of the computer as the information processing apparatus to function as the reception unit and the placement unit.

The present disclosure is also applicable as a program executed by a computer as an information processing apparatus. For example, the above description is also a disclosure of a program causing a computer to function as, with a surface to which ink for forming a print image is applied to a transparent or translucent medium as a first surface and a surface opposite to the first surface as a second surface, a reception function of receiving selection of one mode of a first mode for executing post-processing from the first surface side by a post-processing apparatus that executes the post-processing and a second mode for executing the post-processing from the second surface side by the post-processing apparatus, and a placement function of setting different placements of an object contained in the print image and used for the post-processing when viewed from the first surface side depending on the mode received by the reception function.

The system, the program, and the method as described above may be implemented as a single device or may be implemented by using components provided in a plurality of devices, and may include various forms. Also, suitable changes can be made, such as a part being software and a part being hardware. The present disclosure is further implemented as a recording medium for a program for controlling the system. Obviously, the recording medium for the program may be a magnetic recording medium or a semiconductor memory, and any recording medium to be developed in the future can be also considered in exactly the same way.

What is claimed is:

1. An information processing apparatus comprising:
with a surface to which ink for forming a print image is applied to a transparent or translucent medium as a first surface and a surface opposite to the first surface as a second surface,
a reception unit that receives selection of one mode of a first mode for executing post-processing from the first surface side by a post-processing apparatus that executes the post-processing and a second mode for executing the post-processing from the second surface side by the post-processing apparatus; and
a placement unit that sets different placements of an object contained in the print image and used for the post-processing when viewed from the first surface side depending on the mode received by the reception unit.

2. The information processing apparatus according to claim 1, wherein
with a direction of a relative movement between a printing unit of a printing apparatus that forms the print image and the medium in a period in which the ink is applied to the medium by the printing unit as a main scanning direction,
the placement unit sets different placements of the object when viewed from the first surface side in the main scanning direction depending on the mode received by the reception unit.

3. The information processing apparatus according to claim 2, wherein
with the object placed by the placement unit in the first mode as a first object and the object placed by the placement unit in the second mode as a second object,
the placement unit sets a content of the first object when viewed from the first surface side and a content of the second object when viewed from the first surface side in an inversion symmetrical relationship in the main scanning direction.

4. The information processing apparatus according to claim 2, wherein
with the object placed by the placement unit in the first mode as a first object and the object placed by the placement unit in the second mode as a second object,
the placement unit sets a placement of the first object when viewed from the first surface side and a placement of the second object when viewed from the first surface side in an inversion symmetrical relationship in the main scanning direction.

5. The information processing apparatus according to claim 1, wherein
the object is at least one of a barcode for designating a method of the post-processing and a figure for specifying a position of the post-processing.

6. The information processing apparatus according to claim 1, wherein
with the object placed by the placement unit in the first mode as a first object and the object placed by the placement unit in the second mode as a second object,
the first object is detectable from the first surface by the post-processing apparatus, and
the second object is detectable from the second surface by the post-processing apparatus.

7. The information processing apparatus according to claim 1, further comprising a cut data generation unit used by a cut processing apparatus that executes cut processing when the post-processing is cutting, wherein
the cut data generation unit generates first cut data when the reception unit receives selection of the first mode, and
the cut data generation unit generates second cut data different from the first cut data when the reception unit receives selection of the second mode.

8. The information processing apparatus according to claim 7, wherein
with a direction of a relative movement between a printing unit of a printing apparatus that forms the print image and the medium in a period in which the ink is applied to the medium by the printing unit as a main scanning direction,
the cut data generation unit sets the first cut data and the second cut data in an inversion symmetrical relationship in the main scanning direction.

9. A non-transitory computer-readable storage medium storing a program causing a computer to function as:
with a surface to which ink for forming a print image is applied to a transparent or translucent medium as a first surface and a surface opposite to the first surface as a second surface,
a reception function of receiving selection of one mode of a first mode for executing post-processing from the first surface side by a post-processing apparatus that executes the post-processing and a second mode for executing the post-processing from the second surface side by the post-processing apparatus; and
a placement function of setting different placements of an object contained in the print image and used for the post-processing when viewed from the first surface side depending on the mode received by the reception function.

10. An information processing apparatus comprising:
with a surface to which ink for forming a print image is applied to a transparent or translucent medium as a first surface and a surface opposite to the first surface as a second surface,
placing both a first object contained in the print image for execution of post-processing from the first surface side by a post-processing apparatus that executes the post-processing and a second object contained in the print image for execution of the post-processing from the second surface side by the post-processing apparatus, and setting different placements for the first object and the second object from each other when viewed from the first surface side.
